(19) United States
(12) Patent Application Publication
(10) Pub. No.: US 2010/0203868 A1
(43) Pub. Date: Aug. 12, 2010

(54) System and Method for Providing Multiple Itinerary Services

(76) Inventor: Ike Sagie, Haifa (IL)

Correspondence Address: The Law Office of Michael E. Kondoudis, 888 16th Street, N.W., Suite 800, Washington, DC, 20006, US

(21) Appl. No.: 12/370,144

(22) Filed: Feb. 12, 2009

(51) Int. Cl. H04W 4/02; H04M 3/42; G06Q 30/00; G01C 21/36

(52) U.S. Cl. 455/414.1; 705/34; 701/202; 701/210; 455/456.3

(57) ABSTRACT

System and method for providing itinerary services for travelers and users, where the travelers travel in at least one predefined traveling area. The system includes mobile communication devices, each of which comprises a positioning system enabled to locate the location of the device. Each device further enables the traveler to document the journey by enabling the traveler to acquire and insert content data and transmit the content data; at least one virtual travel journal enabling each traveler to document his journey by acquiring content data that is associated with the location of the traveler at the time the content was acquired. The system may also include at least one visual online viewer enabling a user to monitor the traveling of the traveler in real time; and a main server that enables receiving, processing, analyzing and storing data transmitted from the virtual travel journal, and presenting the data in real time to users through the visual online viewer.

### BACKGROUND

1. Field of the Invention

The present invention relates generally to the field of travel systems and methods and more particularly to computerized systems and methods for providing various itinerary services.

2. Discussion of Related Art

When going on a trip it is always nice and enriching to acquire knowledge of locations visited while traveling and to keep record by, for instance, taking pictures and video films relating to at least some of the locations visited.

Travelers usually need several different storage platforms in which this recorded content can be kept, in cases where the traveler has used various devices and content recording types of data: video films of trips may be stored in video hardware (e.g. video cassettes or CDs); photos may be kept in a digital or non-digital albums, etc.

Existing software and hardware tools enable storing electronic content taken in a traveling session (a trip) in a file comprising all content files that are related to the same trip. To view the content each file must be open individually and it requires a sophisticated graphic work to copy and past some of the files' content on a map to show the location related to the file.

The above described method is cumbersome and time consuming and mostly cannot integrate still graphic representation (such as the map, input text and photos) with continuous content (such as video or audio content).

Another issue, is that other user that do not participate in the trip cannot view online inputted content, so if a traveler wishes to show another person content taken in the trip, the presentation must be carried out post facto.

To transmit the content online to another traveler or user, the traveler may use a communication device such as a cellular mobile phone to both input the content (input text, take a photograph, etc.) and send the content through the device's sending options (e.g. SMS, MMS and the like). In this way the recipient will only receive one file at a time and will only be able to view the content without being able to view this content in an over view together with previous content, other travelers' content or the location indication relating to the received content.

### BRIEF SUMMARY

The present invention, according to some embodiments thereof, provides a travel supporting system and method of providing multiple itinerary services for a multiplicity of travelers and users, where the travelers travel in at least one predefined traveling area.

According to embodiments, the system may comprise: a multiplicity of mobile communication devices, each assigned to a different traveler, enabling to communicate with one another through at least one data communication network, wherein each device comprises a positioning system enabling to locate the mobile communication device, wherein each mobile communication device further enables the traveler to document the journey by enabling the traveler to acquire and insert content data and transmit the content data through at least one data communication network; at least one virtual travel journal, which is an application enabling each traveler, using each mobile communication device, to store documented content data, wherein each content data is associated with location of the traveler at the time the content was inserted, and to online view the traveler's location in an online graphical presentation of the traveling area, which changes in real time according to the current location of the traveler; at least one visual online viewer, which is an application enabling at least one user, using a remote computerized system, to monitor the traveling of at least one traveler, by enabling the at least one user to online view a traveling presentation that includes an online graphical presentation of the traveling area and of the location of the at least one traveler, which changes in real time according to the at least one current location of the at least one traveler; and a main server, operatively associated with the mobile communication devices of travelers, the virtual travel journal of each traveler and at least one visual online viewer, wherein the server enables receiving, processing, analyzing and storing data transmitted from the mobile communication devices, and virtual travel journal of the travelers, and presenting the received and analyzed data in real time to users through the at least one visual online viewer.

The travel supporting system may further comprise a tour guide application, enabling to retrieve a known tour plan associated with the traveler, identify the real time location of the traveler in relation to the retrieved tour plan, retrieving content information relating to the identified location and guide the traveler in real time by presenting the retrieved content information relating to the current location of the traveler and of future expected location.

The travel supporting system may further comprise a tour planner, which may be a planning tool enabling users to plan tour plans, store the plans and download tour plans to the tour guide for enabling the tour guide to use the plan for guiding at least one of the travelers.

The virtual travel journal, the tour guide, the visual online viewer and the tour planner may all be compatible to one another, to allow using data from one application in another.

A method of providing multiple itinerary services for travelers and users, where the travelers travel in at least one predefined traveling area.

According to embodiments, the method may comprise: documenting a journey, wherein at least one traveler is enabled to acquire and insert content data during the traveling in the predefined traveling area, using a mobile communication device, wherein the acquired and inserted content data is associated with the location and time at which the acquisition and insertion were carried out; locating at least one traveler in real time, using a positioning device; receiving the acquired content and the location data associated in real time; monitoring at least one traveler in real time, while the at least one traveler is traveling, by online presenting a traveling presentation in real time, wherein the traveling presentation includes a graphical presentation of the travelers' traveling area and of the location of at least one traveler, wherein the presentation changes in real time according to the current location of the at least one traveler.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a block diagram schematically illustrating a travel supporting system, according to some embodiments of the invention;

FIG. 2 is a schematic illustration of a communication device of a travel supporting system, according to some embodiments of the invention;

FIG. 3 is a schematic illustration of a virtual touring main application, according to some embodiments of the invention;

FIG. 4 is a flowchart, schematically illustrating a method of documenting a journey, according to some embodiments of the invention;

FIG. 5 is a flowchart, schematically illustrating a method of online monitoring at least one traveler traveling in a predefined traveling area, according to some embodiments of the invention; and

FIG. 6 is a flowchart, schematically illustrating a method of planning a journey and using a journey plan for guiding a traveler, according to some embodiments of the invention.

### DETAILED DESCRIPTION OF SOME EMBODIMENTS

While the description below contains many specifications, these should not be construed as limitations on the scope of the invention, but rather as exemplifications of the preferred embodiments. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention, in some embodiments thereof, provides a system and a for providing multiple itinerary services for a multiplicity of travelers, traveling in at least one predefined traveling area, as well as for a multiplicity of users. The services may facilitate the traveler and/or the user in itinerary activities such as recording content related to locations visited in the journey, guiding the travelers, viewing the travelers' location and recorded content in real time, and more.

According to some embodiments, the travel supporting system may enable a traveler to online manage and create a personal journal of the traveler's journey comprising various inputted content types (e.g. audio, text, video, image, or a combination thereof) and the locations related to each content inserted. The system may further enable a user (other than the traveler) to follow the journey of at least one traveler in real time by viewing an indication of the location of the at least one traveler and the journey content inserted by the at least one traveler in relation to the location associated with the content of the at least one traveler in real time.

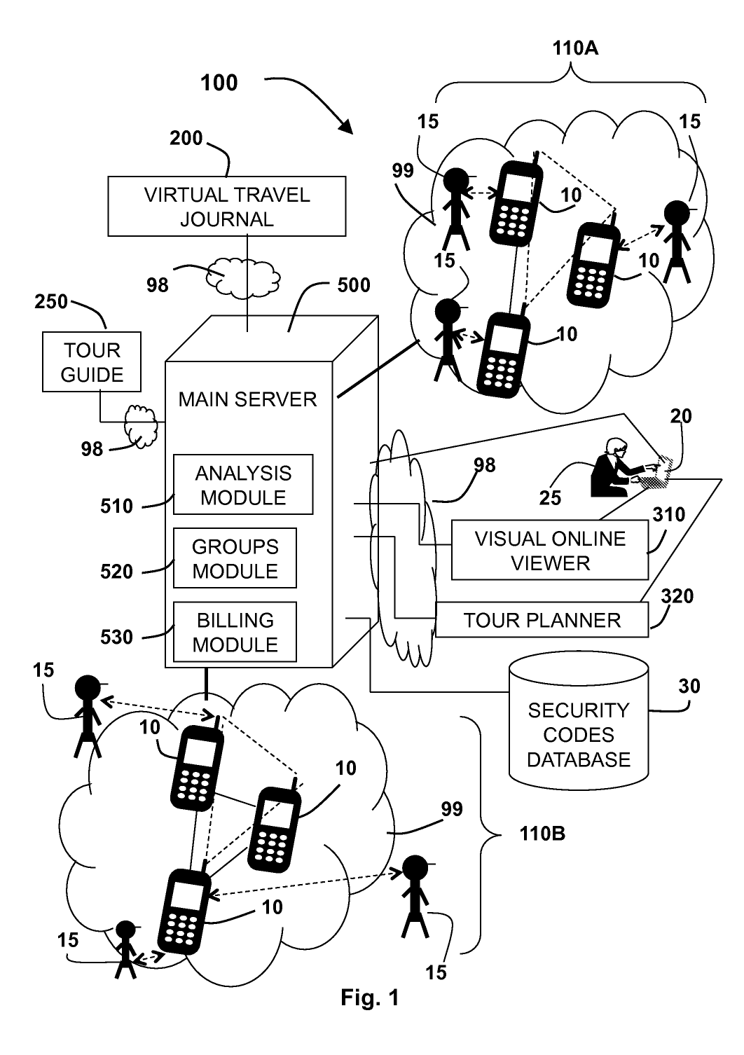

FIG. 1 is a block diagram schematically illustrating a travel supporting system 100, according to some embodiments of the invention. The travel supporting system 100 may comprise:
a multiplicity of mobile communication devices 10, each assigned to at least one traveler 15, enabling the travelers 15 of the same journey (journey group) to communicate with one another through at least one data communication network 99 and/or with other remote communication devices 20 of other users 25, enabled to be located, as well as enabling the traveler 15 to document content data such as textual or media content data (e.g. by enabling the traveler 15 to insert text messages, acquire video/audio/image data etc., as known in the art);
a virtual travel journal 200, which is an application (e.g. web or client) enabling each traveler 15, using each mobile communication device 10, to create a personal journal of his/her journey by storing, receiving and transmitting the content data and location data associated with each content data in real time, where the location data indicates the location where the content data is documented, and to online view the traveler's 15 location in an online graphical presentation of the traveling area, which changes in real time according to the current location of the traveler;
a visual online viewer 310, which is an application enabling users 25, each using a remote computerized system 20, to monitor the traveling of at least one traveler 15, while the at least one traveler 15 is traveling, by enabling the user 25 to online view a traveling presentation, where the traveling presentation includes an online graphical presentation of the traveling area (e.g. map of the traveling area), the location of the at least one traveler 15 and the content documented by the at least one traveler 15 in relation to the location where the content is acquired/inserted, where the presentation may change in real time or near real time, according to the at least one current location of the at leas one traveler 15;
a tour guide 250, which may be an application enabling to guide the traveler 15, using the mobile communication device 10, in real time while the traveler 15 is traveling, for example, by retrieving and presenting information relating to the current location of the traveler 15;
a tour planner 320, which may be an application enabling a user 20 to create and/or customize a tour plan; and
a main server 500, operatively associated with mobile communication devices 10 of travelers 15, the virtual travel journal 200, at least one visual online viewer 310, the tour guide 250, the tour planner 320 and the computerized systems 20 of users 25.

According to embodiments, the main server 500 may enable receiving, processing, analyzing and storing data transmitted from the mobile communication devices 10, and virtual travel journal 200 of the travelers 15, and presenting the received and analyzed data in real time to users 25 through the at least one visual online viewer 310.

According to embodiments, as illustrated in FIG. 1, the main server 500 may comprise:
an analysis module 510, enabled to receive location data and other data (e.g. content data) from the mobile communication devices 10 of the travelers 15 and analyze the received data and to online present the analyzed data in real time to the at least one user's remote computerized system 20 and to the traveler 15;
a groups module 520, where each traveler 15 and the traveler's assigned mobile communication device 10 is associated with one traveling group 110A and 110B, where the group module 520 enables associating each group of travelers 15 and their mobile communication devices 10 to a group 110A and 110B, where each group is associated with its own traveling area; and
a billing module 530, enabling the travelers 15 who are members of the same group 110A or 110B to communicate with one another through their mobile communication devices 10 according to a predefined roaming rate, which may be significantly cheaper than the normally charged rate for calls.

The communication between the mobile communication devices 10 and the main server 500 and or the applications 200, 250, 310 and/or 320 and/or between the server 500 and the users' 25 computerized systems 20 may be via any data communication network(s) 98 and/or 99 known in the art such as the cellular wireless network, the internet or both.

According to embodiments, the applications: the virtual travel journal 200; the tour guide 250; the visual online viewer 310; and the tour planner 320, may all be compatible to one another to allow, for example, (i) using a tour plan, planned by using the tour planner 320 for guiding the traveler 15 when using the tour guide 250, (ii) to allow using the formats of a tour plan planned by using the tour planner 320 to view the graphical presentation (map) and location of the traveler 15 when using the virtual travel journal 200 and/or the visual online viewer 310, and/or (iii) to enable using the data transmitted by the virtual travel journal 200 through the mobile communication device(s) 10 of traveler(s) 15 to the visual online viewer 310.

The mobile communication device 10 may be one of: a mobile phone; a laptop; a PDA (Personal Digital Assistance); and the like as known in the art.

According to embodiments, the mobile communication devices 10 of the travelers 15 may be mobile phones of one or more types and may be associated with one or more cellular operator.

The computerized system 20 may be any computerized system known in the art enabling users 25 to view, receive, transmit and process data such as, for instance, a PC, a laptop, a mobile phone, a PDA and the like, as known in the art.

The virtual travel journal 200 may be one of: a web application; and a client application. In case of a web application, the virtual travel journal 200 may be maintained by the main server 500 and enable using one or more interfaces thereof using the mobile communication device 10. In a case of a client application, the virtual travel journal 200 may be installed in the mobile communication device 10 enabling transmitting the location and content data to the main server 500.

According to embodiments, the visual online viewer 310 may be a web application, maintained by the main server 500, enabling a multiplicity of users 25 to online monitor the same traveler(s) 15 location and documented content, in near real time (depending on the time it takes for the content and location data to be transmitted and presented.

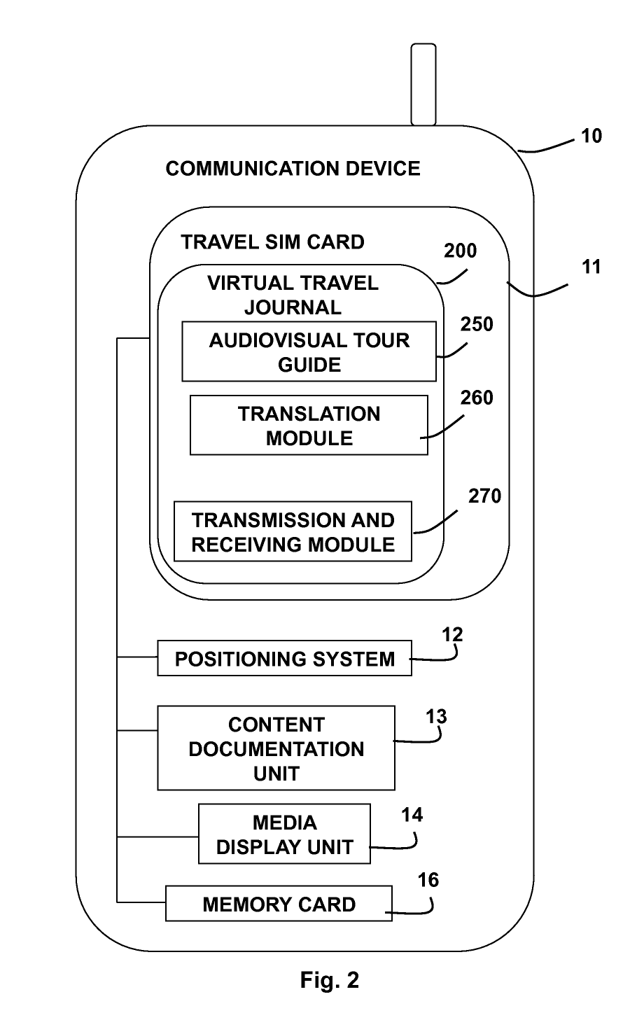

FIG. 2 is a schematic illustration of a mobile communication device 10 of a travel supporting system 100, according to some embodiments of the invention. The mobile communication device 10 may comprise at least some of:
a travel SIM card (Subscriber Identity Module card) 11;
a positioning system 12 (e.g. global positioning system (GPS) or any other system enabling to locate the mobile communication device 10);
a content documentation unit 13, enabling the traveler 15 to insert and acquire media and/or textual content relating to the location of the device 10 at the time of acquiring/inserting the content (e.g. enabling the traveler 15 to acquire photographed images of locations, insert text content, record a voice content and the like);
a media display unit 14 enabling to present (visually and/or aurally) the documented content (e.g. a screen and at least one speaker etc.); and
a memory card 16 enabling to store data such as the acquired/inserted content data for documentation, the location and time parameters associated with the documented data (the time and location at which the content was acquired/inserted) etc.

According to embodiments, as illustrated in FIG. 2, the travel SIM card 11 may comprise the virtual travel journal 200, where the journal 200 may include the tour guide 250 as an aggregated part of the journal 200

According to embodiments, as illustrated in FIG. 2, the virtual travel journal 200 may further comprise at least one of:
a translation module 260 enabling to translate textual and/or aural content data or information arriving from the guide tour 250 or the documentation unit 13 in a first language into at least one other language; and
a transmission and receiving module 270 enabling to receive and transmit data (e.g. to and from one communication device 10 to another and/or to and from the main server 500.

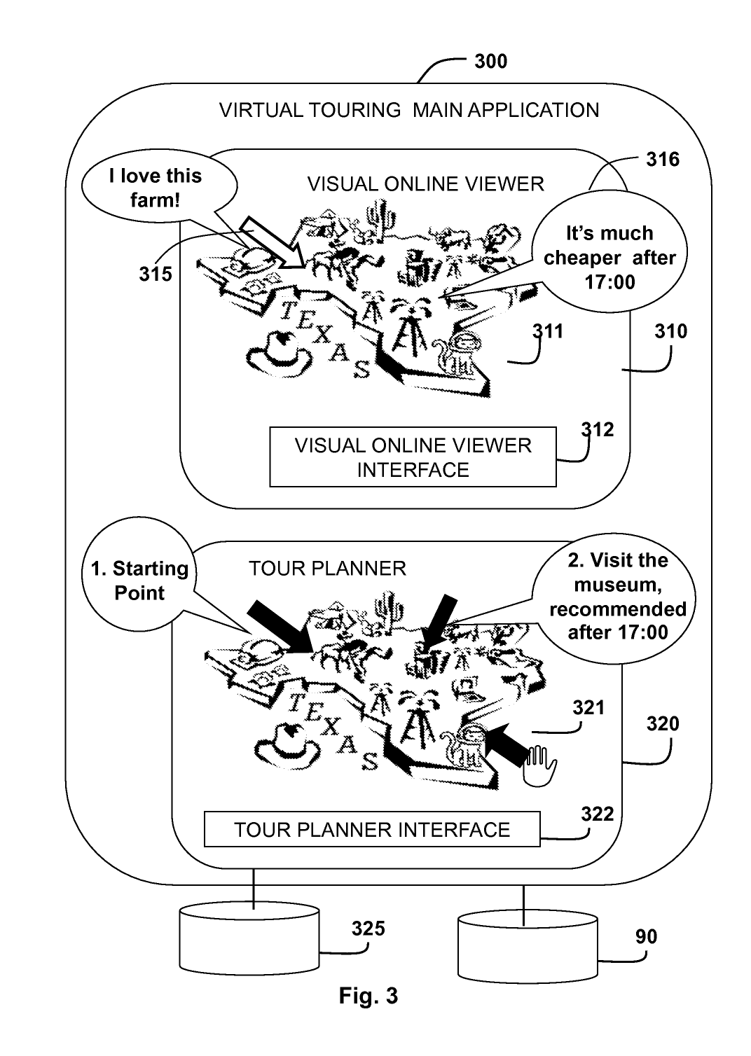

FIG. 3 is a schematic illustration of a virtual touring main application 300, according to some embodiments of the invention. The main application 300 may be a web application installed at the main server 500, according to some embodiments. The main application 300 may enable retrieving and storing graphical presentations (e.g. maps) of various traveling areas from at least one maps database 90.

The virtual tour main application 300 may comprise the visual online viewer 310 (which may be a web application) and the tour planner 320 all aggregated in the main application 300 to allow users 25 to receive both itinerary services in a single web application using a single website aggregating those applications.

According to embodiments, as illustrated in FIG. 3, the visual online viewer 310 may present a graphical presentation of the traveling area 311, which may be a map of the traveling area, where the real time location of the traveler(s) 15 may be presented by traveler indicators 315 located on the presentation of the traveling area 311 (map) in positions that correspond to the real time locations of the traveler(s) 15 at the traveling area. The location of the traveler indicators 315 as well as the zooming presentation of the map 311 may change in time according to the changes in the traveler(s) 15 real time locations at the traveling area.

According to embodiments, the content documented by the traveler(s) 15 may further be presented in positions that correspond to the locations where the traveler(s) 15 is (are) located at the time the content is acquired/inserted and transmitted to the main server 500.

The visual online viewer 310 may further comprise an interface 312 enabling the user 25 to select a traveling area and/or a traveler(s) 15 the user 25 wishes to monitor. The interface 312 may further include a security input interface, enabling the user 25 to enter secured monitoring options (such as travelers 15 that can only be monitored by a user 25 that knows the security input password, etc, as known in the art).

According to embodiments, as illustrated in FIG. 3, the tour planner 320 may comprise an area presentation 321 and a tour planner interface 322 enabling a user 25 to select a desired traveling area for tour planning, presenting the selected area and create a personal tour plan. The tour planner 320 may further enable retrieving a known tour plan of the selected traveling area from at least one plans database 325, which may include ready made, accumulated past travelers' 15 journals and other users' 25 customized and/or created tour plans.

The tour planner interface 322 may enable the user 25 to customize the retrieved plan and save the customized plan as a new personal tour plan.

The plans database 325 may comprise plans associated with various traveling areas or alternatively a multiplicity of plans databases 325 each associated with a specific traveling area may be provided.

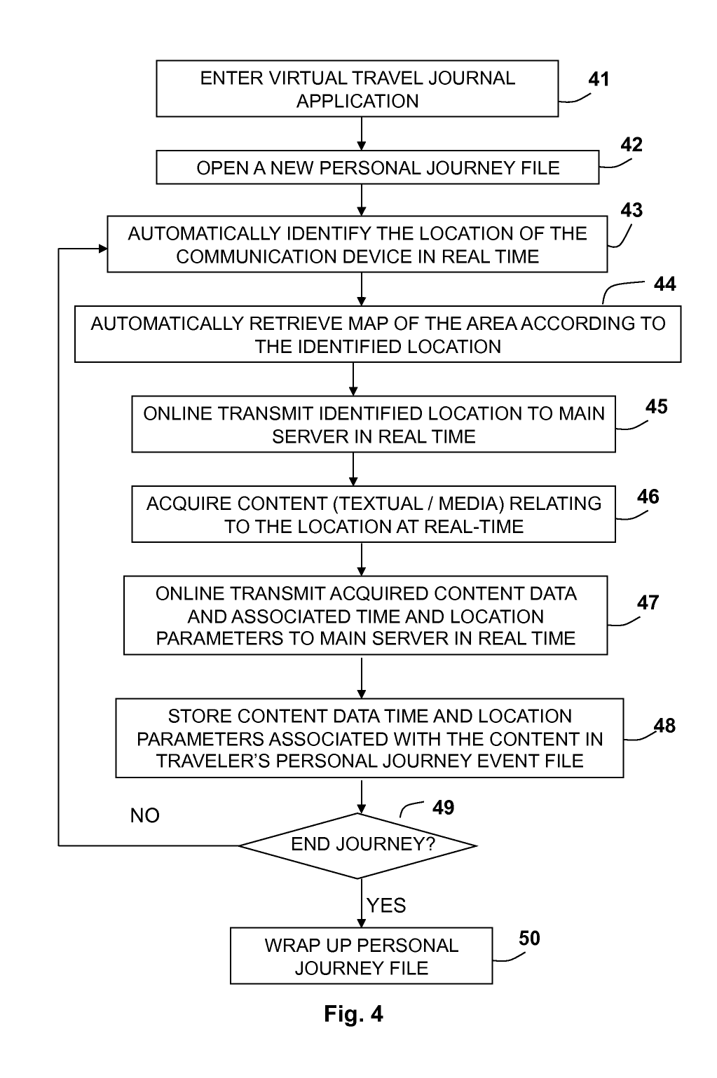

FIG. 4 is a flowchart, schematically illustrating a method of journaling a traveling journey, according to some embodiments of the invention. The documenting method may comprise:
entering the virtual travel journal 41;
opening a new personal journey file 42;
automatically identifying the location of the mobile communication device of the traveler in real time 43;
automatically retrieving a graphical representation (map) of the traveling area, according to the identified location 44 indicating the location of the traveler in real time;
online transmitting the location data of the traveler top the main server 500 in real time 45;
documenting content data (e.g. by acquiring a picture of object(s) in the location, video filming the location, etc. inserting textual message, recording aural message, etc.) 46; transmitting the content data and associated time and location parameters to the main server 500 in real time 47;
storing the documented content data and the location and time parameters at which the acquiring/inserting has occurred in the traveler's personal journey file 48; and
if the journey is ended (e.g. by a traveler's selection to end the journey session in the virtual travel journal 200 interface) 49, all data stored may be wrapped up as a personal journey file of the traveler 50.

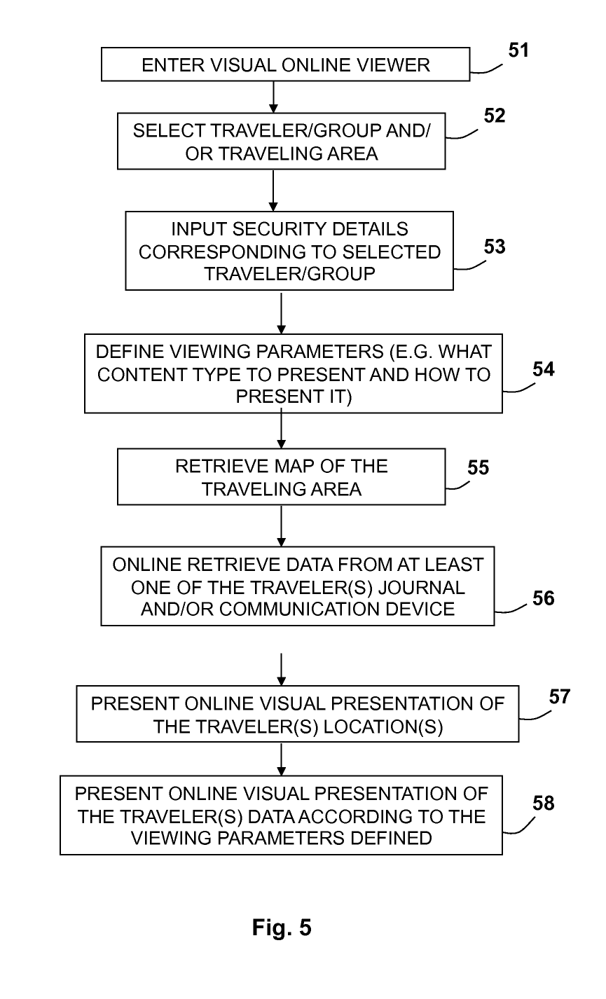

FIG. 5 is a flowchart, schematically illustrating a method of online monitoring at least one traveler 15 traveling in a predefined traveling area, according to some embodiments of the invention. The monitoring method may comprise:
entering the visual online viewer 51;
selecting a specific traveler 15/a group of travelers 15/a traveling area 52; inputting security details corresponding to the selected traveler 15/group of travelers 15/traveling area 53;
defining viewing parameters (what types of content data to present and how to present it) 54;
retrieving a presentation (map) of the traveling area 55;
online retrieving of location and content data from the mobile communication device(s) 10 of at least one of the selected travelers 56;
present an online visual presentation (e.g. through indicators) of the traveler(s) 15 location(s) 57; and
present an online visual presentation of transmitted content data of the traveler(s) 15, according to the viewing parameters defined 58.

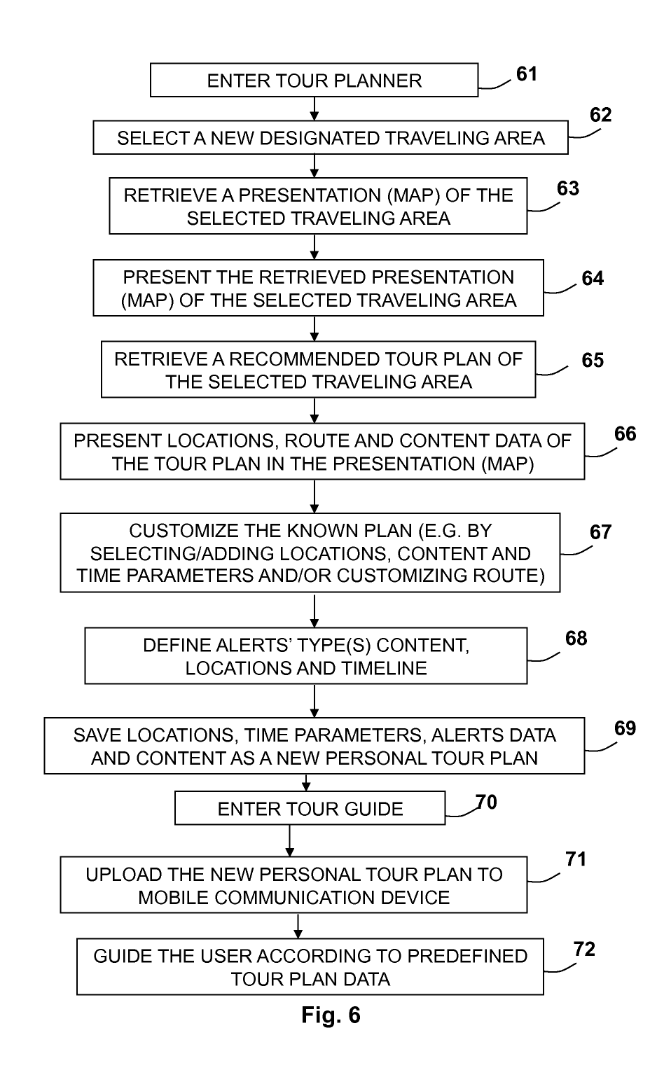

FIG. 6 is a flowchart, schematically illustrating a method of planning a journey and using a journey plan for guiding a traveler, according to some embodiments of the invention.

The planning and guiding method may comprise:
entering the tour planner 61 (e.g. through the user's 25 computerized system 20);
selecting a new designated traveling area 62;
retrieving a presentation (map) of the selected traveling area 63;
presenting the retrieved presentation (map) 64;
retrieving a recommended tour plan of the selected traveling area 65;
presenting locations, route and content of the recommended tour plan in the presentation (map) 66;
customizing the recommended tour plan (e.g. by selecting/removing and/or adding locations, content and a traveling route) 67;
defining alerts' type and content and defining their associated time and location parameters 68 (e.g. a popup window notifying the rate of entrance fees to a site);
saving all locations, route, content and alerts as a new personal tour plan 69, where all selected, added and customized data is translated into guiding commands, which can be later on be operated to guide the traveler 15;
entering the tour guide 70 (e.g. through the traveler's 15 mobile communication device 10);
uploading the stored personal tour plan 71; and
guiding the traveler 15 by operating the guiding commands of the tour plan 72.

According to embodiments, the tour planner 320 may further enable optimizing a tour plan of a specific traveling area out of a multiplicity of known tour plans of the area, according to various predefined optimization conditions and rules, where the optimized plan may be the recommended tour plan. For example, only the data (content and route of a journey plan) from the three most viewed plans may be taken, where the route of the tour may be calculated according to feedbacks of travelers 15 and/or users 25.

While the invention has been described with respect to a limited number of embodiments, these should not be construed as limitations on the scope of the invention, but rather as exemplifications of some of the preferred embodiments. The scope of the invention should not be limited by what has thus far been described, but by the appended claims and their legal equivalents.

What is claimed is:

1. A travel supporting system for providing multiple itinerary services for a multiplicity of travelers and users, wherein the travelers travel in at least one predefined traveling area, the system comprising:
a multiplicity of mobile communication devices, each assigned to at least one different traveler, enabled to communicate with one another through at least one data communication network, wherein each device comprises a positioning system enabling to locate the mobile communication device, wherein each mobile communication device further enables the traveler to document the journey by enabling the traveler to acquire and insert content data and transmit the content data through at least one data communication network;
at least one virtual travel journal, which is an application enabling each traveler, using each mobile communication device, to store documented content data, wherein each content data is associated with location of the traveler at the time the content was inserted, and to online view the traveler's location in an online graphical presentation of the traveling area, which changes in real time according to the current location of the traveler;
at least one visual online viewer, which is an application enabling at least one user, using a remote computerized system, to monitor the traveling of at least one traveler, by enabling the at least one user to online view a traveling presentation that includes an online graphical presentation of the traveling area and of the location of the at least one traveler, which changes in real time according to the at least one current location of the at least one traveler; and
a main server, operatively associated with the mobile communication devices of travelers, the virtual travel journal of each traveler and at least one visual online viewer, wherein the server enables receiving, processing, analyzing and storing data transmitted from the mobile communication devices, and virtual travel journal of the travelers, and presenting the received and analyzed data in real time to users through the at least one visual online viewer.

2. The travel supporting system of claim 1, wherein the main server comprises at least one of:
an analysis module, enabling to receive location data and other data from the mobile communication devices of the travelers and analyze the received data and to online present the analyzed data in real time to the at least one user's remote computerized system and to the traveler;
a groups module, wherein each traveler and the traveler's assigned mobile communication device are associated with one traveling group, wherein the group module enables associating each group of travelers and their mobile communication devices to a group, wherein each group is associated with its own traveling area; and
a billing module, enabling the travelers who are members of the same group to communicate with one another through their mobile communication devices according to a predefined roaming rate, which is significantly cheaper than the normally charged rate for calls.

3. The travel supporting system of claim 1, wherein the traveling presentation further includes presenting at least some of the content inserted by at least one of the travelers, in near real time.

4. The travel supporting system of claim 1, wherein the visual online viewer further enables the user to input identification details for allowing only authorized users to view at least one online traveling event, which the user is authorized to view.

5. The travel supporting system of claim 1, further comprising a tour guide application, enabled to retrieve a tour plan associated with the traveler, identify the real time location of the traveler in relation to the retrieved tour plan, retrieving content information relating to the identified location and guide the traveler in real time by presenting the retrieved content information relating to the current location of the traveler and of future expected location.

6. The travel supporting system of claim 5, further comprising a tour planner, which is a planning tool enabling users to plan tour plans, store the plans and download tour plans to the tour guide for enabling the tour guide to use the plan for guiding at least one of the travelers.

7. The travel support system of claim 6, wherein the virtual travel journal, the tour guide, the visual online viewer and the tour planner are all compatible to one another, to allow using data from one application in another.

8. The travel support system of claim 7, wherein the tour planner further enables the user to retrieve and insert content relating to each location along the plan, wherein the tour guide enables retrieving a tour plan, guiding the traveler according the tour plan and presenting the content relating to each location in real time, when the traveler arrives at the location associated with the content.

9. The travel support system of claim 7, wherein the tour planner further enables the user to retrieve and modify tour plans, retrieved from at least one database comprising known tour plans.

10. The travel supporting system of claim 9, wherein the at least one main server is operatively associated with the virtual travel journal, the travelers' mobile communication devices and positioning systems, the visual online viewer and with the location module,
wherein the at least one main server enables communicating with the mobile communication devices of the travelers and the remote computerized systems of the users through at least one data communication device, and
wherein the at least one main server further enables maintaining a virtual touring main application comprising the visual online viewer and the tour planner, enabling the multiplicity of users to view a multiplicity of travelers' traveling route and inserted content in real time and create and modify tour plans.

11. The travel supporting system of claim 10, wherein the at least one main server further comprises:
a groups module, wherein each traveler and the traveler's assigned mobile communication device is associated with one traveling group, and wherein the group module enables presenting the travelers in the group the same visual presentation of the traveling area and viewing the content inserted by other travelers of the group; and
a billing module, enabling the travelers who are members of the group to communicate with one another through their mobile communication devices according to a predefined roaming rate, wherein the billing module enables billing the travelers according to the predefined roaming rate and according to the time of each call.

12. The travel support system of claim 10, wherein the mobile communication device is a mobile phone, enabling communication via at least one wireless data communication network.

13. The travel support system of claim 12, wherein each mobile phone comprises:
a SIM card enabling to store, analyze and access data, as well as to receive and transmit data through at least one data communication device;
the positioning system, enabling to locate the mobile phone;
a memory card, enabling to store itinerary data; and
a media display unit, enabling to display aural and visual media content, wherein the virtual travel journal and tour guide applications are installed in the SIM card.

14. The travel supporting system of claim 13, wherein the tour guide application is further installed in the SIM card of each mobile phone.

15. The travel supporting system of claim 1, wherein the content inserted by the traveler includes at least one of: textual content; video content; image content; and aural content.

16. The travel supporting system of claim 1, wherein the virtual travel journal further enables the traveler to insert feedbacks content related to at least one of the locations in the travel area.

17. A computer implemented method of providing multiple itinerary services for travelers and users, wherein the travelers travel in at least one predefined traveling area, the method comprising:
documenting a journey, wherein at least one traveler is enabled to acquire and insert content data during the traveling in the predefined traveling area, using a mobile communication device, wherein the acquired and inserted content data is associated with the location and time at which the acquisition and insertion were carried out;
locating at least one traveler in real time, using a positioning device;
receiving the acquired content and the location data associated in real time;
monitoring at least one traveler in real time, while the at least one traveler is traveling, by online presenting a traveling presentation in real time, wherein the traveling presentation includes a graphical presentation of the travelers' traveling area and of the location of at least one traveler,
and wherein the presentation changes in real time according to the current location of the at least one traveler.

18. The method of claim 17, wherein the acquiring of content data is carried out by at least one of: filming a video of an area visited that is in the area of the traveler's location when filming; acquiring images of the location by taking at least one picture; and recording sounds from the location.

19. The method of claim 17, wherein the inserting of content data is carried out by at least one of: inserting text messages; and inserting aural messages.

20. The method of claim 17, further comprising:
opening a new personal journey file; and
storing all the documented content data, the locations and the time parameters associated with the content data and all the locations identified in the journey.

21. The method of claim 17, further comprising:
retrieving the graphical representation of the traveling area; and
presenting the representation and the real time location of the traveler to the traveler.

22. The method of claim 17, further comprising inputting security details, wherein the user inputs the security details that enable the user to online view traveling area and related data of at least one traveler that is associated with the security details.

23. The method of claim 17, further comprising creating a personal tour plan including:
a planned traveling area;
a tour track including the locations of the traveling area planned to be visited; and
a time schedule for visiting the locations in the traveling area; and other itinerary information.

24. The method of claim 23, further comprising:
retrieving a recommended tour plan; and
customizing the retrieved tour plan to create a personalized tour plan.

25. The method of claim 24, further comprising defining alerts and guiding messages relating to locations in the tour plan.

26. The method of claim 25, further comprising:
uploading a personal tour plan to a tour guide application; and
guiding the traveler according to the tour plan by playing the alerts and guiding messages upon identification of the location associated with each alert and message.
